(19) United States
(12) Patent Application Publication
(10) Pub. No.: US 2022/0039436 A1
(43) Pub. Date: Feb. 10, 2022

(54) FOOD STERILIZATION TUBE AND METHOD FOR MAKING SAME

(71) Applicant: SAINT-GOBAIN PERFORMANCE PLASTICS CORPORATION, Solon, OH (US)

(72) Inventors: John J. HEINDEL, Bordentown, NJ (US); Gerald G. Griffin, Frenchtown, NJ (US); Daniel R. Meyer, Matthews, NC (US)

(21) Appl. No.: 17/444,481

(22) Filed: Aug. 5, 2021

Related U.S. Application Data
(60) Provisional application No. 63/062,718, filed on Aug. 7, 2020.

(51) Int. Cl. A23L 3/00; F16L 11/04; B29C 48/18; B29C 48/00; A23L 3/01

(52) U.S. Cl. CPC A23L 3/001; F16L 11/04; B29K 2027/18; B29C 48/022; A23L 3/01; B29C 48/18

(57) ABSTRACT

A food sterilization tube includes a layer including a fluoropolymer, wherein the fluoropolymer includes a copolymer of tetrafluoroethylene and perfluoropropyl vinyl ether (PFA), a fluorinated ethylene propylene copolymer (FEP), polytetrafluoroethylene (PTFE), or combination thereof, wherein the fluoropolymer has a dielectric constant of less than 3 as measured by ASTM D150.

### CROSS-REFERENCE TO RELATED APPLICATION(S)

This Application claims priority under 35 U.S.C. § 119(e) to U.S. Provisional Patent Application No. 63/062,718, entitled “FOOD STERILIZATION TUBE AND METHOD FOR MAKING SAME,” by John J. HEINDEL et al., filed Aug. 7, 2020, which is assigned to the current assignee hereof and incorporated herein by reference in its entirety.

### FIELD OF THE DISCLOSURE

This application in general relates to a food sterilization tube and method for making same.

### BACKGROUND

Hoses and tubing are used in a variety of industries including food processing, chemical industries, pharmaceutical industries, and fuel industries. In such industries, fluid conduits that have a low surface energy inner surface are used because they are easy to clean and resistant to contaminants. In particular, such industries are turning to low surface energy polymers such as fluoropolymers. However, such fluoropolymers are expensive and often have undesirable properties for certain applications.

Several industries use such fluoropolymers as the contact layer for a fluid. Unfortunately, for certain applications, some fluoropolymers do not have the required burst pressure resistance and high temperature resistance for certain applications. For instance, when exposed to high temperatures and pressures, failure of the fluoropolymer can occur. In particular, microwave sterilization of food requires temperature exposure in excess of 300° F. and high-volume flow rates.

As such, an improved tube for food sterilization would be desirable.

### SUMMARY

In an embodiment, a food sterilization tube includes: a layer including a fluoropolymer, wherein the fluoropolymer includes a copolymer of tetrafluoroethylene and perfluoropropyl vinyl ether (PFA), a fluorinated ethylene propylene copolymer (FEP), polytetrafluoroethylene (PTFE), or combination thereof, wherein the fluoropolymer has a dielectric constant of less than 3 as measured by ASTM D150.

In another embodiment, a method of making a food sterilization tube includes providing a layer including a fluoropolymer, wherein fluoropolymer includes a copolymer of tetrafluoroethylene and perfluoropropyl vinyl ether (PFA), a fluorinated ethylene propylene copolymer (FEP), or combination thereof, wherein the fluoropolymer has a dielectric constant of less than 3 as measured by ASTM D150.

In a particular embodiment, a food sterilization tube includes a layer including a fluoropolymer, wherein the fluoropolymer layer has a dielectric constant of less than 3 as measured by ASTM D150, a tensile strength of at least 1,000 psi at a temperature of 300° F., and a gas permeation rate of less than 1000 (cm³·mil thickness)/(100 in²·24 hr·atm) as measured by ASTM D1434.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of an exemplary food sterilization tube; and

FIG. 2 includes an illustration of an exemplary multi-layer food sterilization tube.

The use of the same reference symbols in different drawings indicates similar or identical items.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises”, “comprising”, “includes”, “including”, “has”, “having” or any other variation thereof, are open-ended terms and should be interpreted to mean “including, but not limited to . . . .” These terms encompass the more restrictive terms “consisting essentially of” and “consisting of.” In an embodiment, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in reference books and other sources within the structural arts and corresponding manufacturing arts. Unless indicated otherwise, all measurements are at about 23° C. +/−5° C. per ASTM, unless indicated otherwise.

In a particular embodiment, a food sterilization tube is provided. The food sterilization tube includes at least one layer of a fluoropolymer. Advantageously, the food sterilization tube has properties for applications that include exposure to high temperature, exposure to pressure, or combination thereof. A method of making a food sterilization tube is further provided.

The fluoropolymer layer of the tube typically includes a melt processable fluoropolymer. “Melt processable fluoropolymer” as used herein refers to a fluoropolymer that can melt and flow to extrude in any reasonable form such as a film, tube, fiber, molded article, or sheet. An exemplary melt processable fluoropolymer of the tube may be formed of a homopolymer, copolymer, terpolymer, or polymer blend formed from a monomer, such as tetrafluoroethylene, hexafluoropropylene, chlorotrifluoroethylene, trifluoroethylene, vinylidene fluoride, vinyl fluoride, perfluoropropyl vinyl ether, perfluoromethyl vinyl ether, or any combination thereof. An exemplary melt processable fluoropolymer includes a copolymer of a poly vinylidene fluoride (PVDF) and a hexafluoropropylene (HFP), a polytetrafluoroethylene (PTFE), a fluorinated ethylene propylene copolymer (FEP), a copolymer of tetrafluoroethylene and perfluoropropyl vinyl ether (PFA), a copolymer of tetrafluoroethylene and perfluoromethyl vinyl ether (MFA), a copolymer of ethylene and tetrafluoroethylene (ETFE), a copolymer of ethylene and chlorotrifluoroethylene (ECTFE), a polychlorotrifluoroethylene (PCTFE), a poly vinylidene fluoride (PVDF), a terpolymer including a tetrafluoroethylene, a hexafluoropropylene, and a vinylidenefluoride (THV), a polyvinyl fluoride (PVF, e.g., Tedlar™), a terpolymer of tetrafluoroethylene, hexafluoroproplyene, and ethylene, any blend, any alloy, or combination thereof. In a particular embodiment, the fluoropolymer has a dielectric constant of less than 3.0, such as 1 to 3, such as 1.5 to 2.5, or even 1.8 to 2.3 as measured by ASTM D150. In a particular embodiment, the fluoropolymer layer having a dielectric constant of less than 3.0 includes a copolymer of tetrafluoroethylene and perfluoropropyl vinyl ether (PFA), a fluorinated ethylene propylene copolymer (FEP), polytetrafluoroethylene (PTFE), or combination thereof. In a more particular embodiment, the fluoropolymer layer includes a copolymer of tetrafluoroethylene and perfluoropropyl vinyl ether (PFA). In an embodiment, the fluoropolymer layer provides advantageous properties to the food sterilization tube.

In a further embodiment, the fluoropolymer layer may include any additive envisioned. The additive may include, for example, a co-agent, an antioxidant, a filler, an ultraviolet (UV) agent, a dye, a pigment, an anti-aging agent, a plasticizer, the like, or combination thereof. In an embodiment, the co-agent is a cross-linking agent provided to increase and/or enhance crosslinking of the fluoropolymer composition of the fluoropolymer layer. In a further embodiment, the use of a co-agent may provide desirable properties such as decreased permeation of small molecules and improved elastic recovery of the fluoropolymer layer compared to a fluoropolymer layer that does not include a co-agent. Any co-agent is envisioned such as, for example, bis-phenol AF, triaryl isocyanurate (TAIC), triaryl cyanurate (TAC), an organic peroxide, or combination thereof. Any amount of co-agent is envisioned. Alternatively, the fluoropolymer layer may be substantially free of a crosslinking agent, a co-agent, a photoinitiator, a filler, a plasticizer, or a combination thereof. “Substantially free” as used herein refers to less than about 1.0% by weight, or even less than about 0.1% by weight of the total weight of the fluoropolymer.

In a particular embodiment, the fluoropolymer layer includes at least 70% by weight of the fluoropolymer. For example, the fluoropolymer layer may include at least 85% by weight fluoropolymer, such as at least 90% by weight, at least 95% by weight, or even 100% by weight of the fluoropolymer. In an example, the fluoropolymer layer may consist essentially of the fluoropolymer. In a particular example, the fluoropolymer layer may consist essentially of the copolymer of tetrafluoroethylene and perfluoropropyl vinyl ether (PFA), a fluorinated ethylene propylene copolymer (FEP), polytetrafluoroethylene (PTFE), or combination thereof. In a particular example, the fluoropolymer layer may consist essentially of the copolymer of tetrafluoroethylene and perfluoropropyl vinyl ether (PFA). As used herein, the phrase “consists essentially of” used in connection with the fluoropolymer of the fluoropolymer layer precludes the presence of other fluoropolymers and non-fluorinated polymers that affect the basic and novel characteristics of the fluoropolymer, although, commonly used processing agents and additives such as antioxidants, fillers, UV agents, dyes, pigments, anti-aging agents, and any combination thereof may be used in the fluoropolymer. In a particular example, the fluoropolymer layer may consist of the copolymer of tetrafluoroethylene and perfluoropropyl vinyl ether (PFA), a fluorinated ethylene propylene copolymer (FEP), polytetrafluoroethylene (PTFE), or combination thereof. In a particular example, the fluoropolymer layer may consist of the copolymer of tetrafluoroethylene and perfluoropropyl vinyl ether (PFA).

In an example, the fluoropolymer layer of the food sterilization tube has desirable mechanical properties, such as a desirable tensile strength, gas permeation rate, and surface roughness. In an embodiment, the fluoropolymer layer has a tensile strength of at least 1000 psi at a temperature of 300° F. The fluoropolymer layer has a gas permeation rate of less than 1000 (cm³·mil thickness)/(100 in²·24 hr·atm) as measured by ASTM D1434. In a particular embodiment, the fluoropolymer layer has a surface, such as an inner surface, an outer surface, or combination thereof, having a surface roughness (Ra) of 4.5 μin or less, as measured by ASTM D7127.

The food sterilization tube may include an outer layer. In an embodiment, the outer layer has advantageous properties for food sterilization applications. For instance, the outer layer includes a polymer having a tensile strength at yield of at least 1,000 psi, such as greater than 1,500 psi, or even greater than 2,000 psi, as measured by ASTM D3307 at a temperature of 300° F. Further, the polymer of the outer layer has a dielectric constant of less than 3 as measured by ASTM D150. Exemplary polymers include, but are not limited to, a polyimide (PI), a polyamide imide (PAI), a copolymer of tetrafluoroethylene and perfluoropropyl vinyl ether (PFA), a polyether ether ketone (PEEK), a polyphenylene sulfide (PPS), a polysulfone (PSU), a polyether imide (PEI), or combination thereof. In an embodiment, the polymer of the outer layer includes polyether ether ketone (PEEK).

In a particular example, the polymer of the outer layer is self-bonding. For a self-bonding polymer, a modification to the polymer, either through grafting a chemically active functionality onto the polymeric chain within the polymer or through incorporation of a separate chemical component into the matrix of the polymer, leads to enhanced bonding between the polymer and the layer it is directly adjacent to. Any chemically active functionality, chemical component, or combination thereof is envisioned.

In an exemplary embodiment, the polymer of the outer layer may further include any reasonable additive such as a crosslinking agent, a co-agent, a photoinitiator, a filler, a plasticizer, or any combination thereof. Any co-agent is envisioned that increases and/or enhances crosslinking of the polymer composition of the outer layer. In a further embodiment, the use of a co-agent may provide desirable properties such as decreased permeation of small molecules and improved elastic recovery of the outer layer compared to an outer layer that does not include a co-agent. Any co-agent is envisioned such as, for example, bis-phenol AF, triaryl isocyanurate (TAIC), triaryl cyanurate (TAC), an organic peroxide, or combination thereof. Any reasonable amount of co-agent is envisioned. Alternatively, the polymer of the outer layer may be substantially free of any crosslinking agent, co-agent, photoinitiator, filler, plasticizer, or a combination thereof. “Substantially free” as used herein refers to less than about 1.0% by weight, or even less than about 0.1% by weight of the total weight of the polymer of the outer layer.

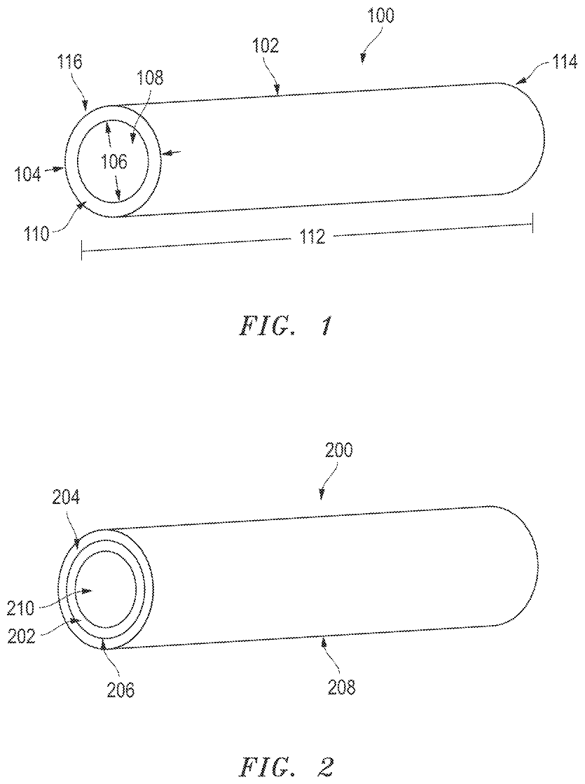

FIG. 1 is a view of a food sterilization tube 100 according to an embodiment. In a particular embodiment, the food sterilization tube 100 can include a body 102 having an outside diameter 104 and an inner diameter 106. The inner diameter 106 can form a hollow bore 108 of the body 102. The hollow bore 108 defines a central lumen of the tube. In addition, the body 102 is illustrated as a fluoropolymer layer, the fluoropolymer layer including the fluoropolymer described above. The fluoropolymer layer can include a layer thickness 110 that is measured by the difference between the outside diameter 104 and the inner diameter 106.

In a particular embodiment, the outside diameter 104 of the body 102 is about 0.25 inches to about 6.0 inches, such as about 0.25 inches to about 2.0 inches, such as about 0.25 inch, about 0.50 inch, about 1.0 inch, about 1.5 inch, and about 2.0 inch. It will be appreciated that the outside diameter 104 can be within a range between any of the minimum and maximum values noted above. In an embodiment, the inner diameter 106 of the body 102 is up to about 4.0 inches, such as about 0.3 inches to about 4.0 inches, such as up to about 2.0 inches, such as about 0.3 inches to about 2.0 inches, such as up to about 1.0 inches, such as about 0.06 inches to about 1.0 inches. It will be appreciated that the inner diameter 106 can be within a range between any of the minimum and maximum values noted above.

The total thickness of the food sterilization tube 100 may be between about 3 mils to about 1500 mils, such as about 3 mils to about 1000 mils, such as about 3 mils to about 500 mils, or even about 3 mils to about 100 mils. For instance, the fluoropolymer layer may have a thickness of about 3 mils to about 1500 mils, such as about 3 mils to about 1000 mils, such as about 3 mils to about 500 mils, or even about 3 mils to about 100 mils. In an embodiment, the fluoropolymer layer may have a thickness 110 of less than about 250 mils, such as about 1 mil to about 250 mils, such as about 50 mils to about 250 mils, or about 100 mils to about 230 mils.

Further, the body 102 can have a length 112, which is a distance between a distal end 114 and a proximal end 116 of the food sterilization tube 100. In a further embodiment, the length 112 of the body 102 can be at least about 5.0 inches, such as at least about 50 inches, such as at least about 100 inches. The length 112 is generally limited by pragmatic concerns, such as storing and transporting long lengths, or by customer demand.

Although the cross-section of the hollow bore 108 perpendicular to an axial direction of the body 102 in the illustrative embodiment shown in FIG. 1 has a circular shape, the cross-section of the hollow bore 108 perpendicular to the axial direction of the body 102 can have any cross-section shape envisioned.

In an alternative embodiment and as seen in FIG. 2, a food sterilization tube 200 is an elongated annular structure with a hollow central bore. The food sterilization tube 200 includes a fluoropolymer layer 202 and an outer layer 204. The outer layer 204 is illustrated as overlying the fluoropolymer layer 202. The fluoropolymer layer 202 may be directly in contact with and may directly bond to the outer layer 204 along an outer surface 206 of the fluoropolymer layer 202. As illustrated, the outer layer 204 provides an outside surface 208 of the food sterilization tube 200. For example, the fluoropolymer layer 202 may directly bond to the outer layer 204 without intervening adhesive layers, such as a primer. In an exemplary embodiment, the food sterilization tube 200 includes two layers, i.e., such as the fluoropolymer layer 202 and the outer layer 204. As illustrated, the fluoropolymer layer 202 includes an inner surface 210 that defines a central lumen of the tube. In an embodiment, the fluoropolymer layer 202 may be the material as described as above. Further, the outer layer 204 may be the material as described above.

Any dimensions of the food sterilization tube 200 are envisioned. For instance, any thickness of the layers 202, 204 is envisioned and is typically dependent upon the final properties desired for the food sterilization tube 200. In an embodiment, the ratio of the thickness of the fluoropolymer layer 202 to the outer layer 204 may be 20:1 to 1:20, such as 10:1 to 1:10. It will be appreciated that the ratio of the thickness can be within a range between any of the minimum and maximum values noted above.

The total thickness of the food sterilization tube 200 may be as described above for the single layer food sterilization tube 100 such as between about 3 mils to about 1500 mils, such as about 3 mils to about 1000 mils, such as about 3 mils to about 500 mils, or even about 3 mils to about 100 mils. In an embodiment, the fluoropolymer layer 202 may have a thickness of less than about 250 mils, such as about 1 mil to about 250 mils, such as about 50 mils to about 250 mils, or about 100 mils to about 230 mils, the outer layer 204 making up the difference. In an embodiment, the outer layer 204 may have a greater thickness than the fluoropolymer layer 202. In an example, the outer layer 204 may have a thickness in a range of about 10 mils to about 1000 mils, such as a range of about 10 mils to about 500 mils, such as a range of about 10 mils to about 100 mils, or even a range of about 10 mils to about 50 mils.

Although illustrated as a single layer tube and a two-layer tube, any number of layers is envisioned. For instance, the food sterilization tube includes one layer, two layers, three layers, or even a greater number of layers. Irrespective of the number of layers present, the outside diameter and inner diameter of the food sterilization tube can have any values as defined for the single layer tube 100 defined in FIG. 1. The number of layers is dependent upon the final properties desired for the food sterilization tube.

In an embodiment, the food sterilization tube may further include other layers. Other layers include, for example, a polymeric layer, a reinforcing layer, an adhesive layer, a barrier layer, a chemically resistant layer, a metal layer, any combination thereof, and the like. Any reasonable method of providing any additional layer is envisioned and is dependent upon the material chosen. Any number of fluoropolymer layers is also envisioned. Further, although FIG. 1 and FIG. 2 illustrate the fluoropolymer layer as having an inner surface that defines a central lumen of the tube, any additional layers can be disposed in any location of a multi-layer tube.

In an embodiment, a surface of at least one layer may be treated to improve adhesion between any of the fluoropolymer layer 202 and the outer layer 204, or combination thereof. Any treatment is envisioned that increases the adhesion between two adjacent layers. For instance, a surface of the fluoropolymer layer 202 that is directly adjacent to the outer layer 204 is treated. For instance, an outside surface of the fluoropolymer layer 202 is surface treated. In an embodiment, a surface of the outer layer 204 that is directly adjacent to the fluoropolymer layer 202 is treated. In an embodiment, the treatment may include surface treatment such as mechanical treatment, chemical treatment, sodium etching, use of a primer, or any combination thereof. In an embodiment, the surface treatment may include corona treatment, UV treatment, electron beam treatment, flame treatment, scuffing, sodium naphthalene surface treatment, or any combination thereof.

In an embodiment, any post-cure step may be envisioned. In particular, the post-cure step includes any radiation treatment such as, for example, e-beam treatment, gamma treatment, or combination thereof. In an example, the gamma radiation or e-beam radiation is at about 0.1 MRad to about 50 MRad. In a particular embodiment, the radiation treatment may be provided to increase interlayer and/or intralayer crosslinking.

In a particular embodiment, the food sterilization tube, such as a fluid conduit is formed by providing the fluoropolymer layer. The fluoropolymer may be provided by any method envisioned and is dependent upon the fluoropolymer chosen for the food sterilization tube. In an embodiment, the fluoropolymer is extruded, injection molded, or mandrel wrapped. In an exemplary embodiment, the fluoropolymer is extruded. In an example, the bond surface of the fluoropolymer layer is prepared with a surface treatment. In an embodiment, the fluoropolymer may be cured before, after, or during application of any further layers on the food sterilization tube. The fluoropolymer layer may be cured in place using a variety of curing techniques such as via heat, radiation, or any combination thereof.

In an embodiment and when present, the outer layer may be provided to overlie the fluoropolymer layer. The outer layer includes a polymer as described above. The polymer may be provided by any method envisioned and is dependent upon the polymer chosen for the outer layer. The method may further include providing the outer layer by any method. Providing the outer layer depends on the polymer material chosen for the outer layer. In an embodiment, the outer layer is extruded or injection molded. In an exemplary embodiment, the outer layer may be extruded. In a particular embodiment, the outer layer is extruded over the fluoropolymer layer and the outer layer is cured. When additional layers are present, the outer layer may be cured before, after, or during application of any further layers on the food sterilization tube. In addition, the outer layer may be cured in place using a variety of curing techniques such as via heat, radiation, or any combination thereof.

In an exemplary embodiment, the fluoropolymer layer is provided by heating the fluoropolymer to an extrusion viscosity and extruding the fluoropolymer to form the fluoropolymer layer. The fluoropolymer layer may then be cured. In an embodiment, the fluoropolymer layer may be cured before, after, or during the application of any of the subsequent layers, if present. In an example and when present, the outer layer is disposed to directly contact the fluoropolymer layer. The outer layer is provided by heating the polymer to an extrusion viscosity and then extruding the polymer. The outer layer may then be cured. In an embodiment, at least two adjacent layers are co-extruded, such as the fluoropolymer layer and the outer layer. Any order of providing each layer is envisioned and any order of cure of each layer is envisioned.

Any post-fitting may be included on the tube. For instance, a fitting may be included on at least one end of the tube. For instance, any fitting is envisioned to provide a connection of the tube to any apparatus envisioned. Fittings include by are not limited to, for example, connectors, sleeves, valves, clamps, flanges, unions, splicers, hosebarbs, plugs, compression fittings, and the like.

Although generally described as a food sterilization tube, any reasonable polymeric article can be envisioned. The polymeric article may alternatively take the form of a film, a washer, or a fluid conduit. For example, the polymeric article may take the form or a film, such as a laminate, or a planar article, such as a septa or a washer. In another example, the polymeric article may take the form of a fluid conduit, such as tubing, a pipe, a hose or more specifically flexible tubing, transfer tubing, pump tubing, chemical resistant tubing, high purity tubing, smooth bore tubing, fluoropolymer lined pipe, or rigid pipe, or any combination thereof.

The food sterilization tube has advantageous properties for microwave sterilization. Microwave sterilization typically includes temperatures sufficient to destroy bacteria or other living microorganisms. Microwave sterilization of food solids and pastes typically includes high temperature exposure in excess of 300° F. and high-volume flow rates. Commercially available food sterilization tubes can withstand a pressure of up to 10 psi. However, the present food sterilization tube has a minimum burst resistant of at least 200 psi. Further the food sterilization tube has a temperature resistant of up to about 400° F. In an embodiment, the food sterilization tube is exposed to microwave radiation. Microwave radiation includes electromagnetic wavelengths from about 1 millimeter (mm) to about 1 meter (m), or frequencies from about 300 gigahertz to about 300 megahertz. Irrespective of the number of layers present in the food sterilization tube, the food sterilization tube has a dielectric constant of less than 3.0, such as 1 to 3, such as 1.5 to 2.5, or even 1.8 to 2.3 as measured by ASTM D150. Further, the food sterilization tube has a tensile strength of at least 1000 psi at a temperature of 300° F.

Applications for the food sterilization tubing are numerous. Although described for food sterilization, the tubing may be used in applications such as food and beverage, industrial, wastewater, digital print equipment, chemical or detergent dispensing, or a liquid transfer tube, such as a chemically resistant liquid transfer tube, automotive, or other applications where high pressure resistance, and/or low gas permeation, and/or high temperature resistance are desired. In a particular embodiment, the polymeric article is used as tubing or hosing to produce food sterilization tubing, fuel pump tubing, reinforced hosing, chemically resistant hosing, braided hosing, and peristaltic pump hosing and tubing.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the items as listed below.

Embodiment 1. A food sterilization tube including: a layer including a fluoropolymer, wherein the fluoropolymer includes a copolymer of tetrafluoroethylene and perfluoropropyl vinyl ether (PFA), a fluorinated ethylene propylene copolymer (FEP), polytetrafluoroethylene (PTFE), or combination thereof, wherein the fluoropolymer has a dielectric constant of less than 3 as measured by ASTM D150.

Embodiment 2. A method of making a food sterilization tube including providing a layer including a fluoropolymer, wherein the fluoropolymer includes a copolymer of tetrafluoroethylene and perfluoropropyl vinyl ether (PFA), a fluorinated ethylene propylene copolymer (FEP), or combination thereof, wherein the fluoropolymer has a dielectric constant of less than 3 as measured by ASTM D150.

Embodiment 3. The food sterilization tube or the method of making the food sterilization tube of any of the preceding embodiments, wherein the fluoropolymer includes a copolymer of tetrafluoroethylene and perfluoropropyl vinyl ether (PFA).

Embodiment 4. The food sterilization tube or the method of making the food sterilization tube of any of the preceding embodiments, wherein the fluoropolymer has a dielectric constant of 1 to 3, such as 1.5 to 2.5, or even 1.8 to 2.3 as measured by ASTM D150.

Embodiment 5. The food sterilization tube or the method of making the food sterilization tube of any of the preceding embodiments, wherein the fluoropolymer layer has a tensile strength of at least 1000 psi at a temperature of 300° F.

Embodiment 6. The food sterilization tube or the method of making the food sterilization tube of any of the preceding embodiments, wherein the fluoropolymer layer has a gas permeation rate of less than 1000 (cm³·mil thickness)/(100 in²·24 hr·atm) as measured by ASTM D1434.

Embodiment 7. The food sterilization tube or the method of making the food sterilization tube of any of the preceding embodiments, wherein the fluoropolymer layer has a surface having a surface roughness (Ra) of 4.5 μin or less, as measured by ASTM D7127.

Embodiment 8. The food sterilization tube or the method of making the food sterilization tube of any of the preceding embodiments, having an inner surface that defines a central lumen of the tube.

Embodiment 9. The food sterilization tube or the method of making the food sterilization tube of any of the preceding embodiments, further including an outer layer including a polymer having a tensile strength at yield of at least 1,000 psi at a temperature of 300° F.

Embodiment 10. The food sterilization tube or the method of making the food sterilization tube of embodiment 9, wherein the polymer outer layer has a tensile strength at yield greater than 1,000 psi, such as greater than 1,500 psi, or even greater than 2,000 psi, as measured by ASTM D3307.

Embodiment 11. The food sterilization tube or the method of making the food sterilization tube of any of embodiments 9-10, wherein the polymer of the outer layer has a dielectric constant of less than 3 as measured by ASTM D150.

Embodiment 12. The food sterilization tube or the method of making the food sterilization tube of any of embodiments 9-11, wherein the polymer of the outer layer includes a polyimide (PI), a polyamide imide (PAI), a copolymer of tetrafluoroethylene and perfluoropropyl vinyl ether (PFA), a polyether ether ketone (PEEK), a polyphenylene sulfide (PPS), a polysulfone (PSU), a polyether imide (PEI), or combination thereof.

Embodiment 13. The food sterilization tube or the method of making the food sterilization tube of embodiment 12, wherein the polymer of the outer layer includes polyether ether ketone (PEEK).

Embodiment 14. The food sterilization tube or the method of making the food sterilization tube of embodiments 9-13, wherein the outer layer is disposed directly on the fluoropolymer layer.

Embodiment 15. The food sterilization tube or the method of making the food sterilization tube of any of the preceding embodiments, further including a fitting on at least one end of the food sterilization tube.

Embodiment 16. The food sterilization tube or the method of making the food sterilization tube of any of the preceding embodiments, wherein the fluoropolymer layer has a thickness of less than about 250 mils, such as about 1 mil to about 250 mils, such as about 50 mils to about 250 mils, or about 100 mils to about 230 mils.

Embodiment 17. The food sterilization tube or the method of making the food sterilization tube of any of embodiments 9-16, wherein the outer layer has a thickness of about 10 mils to about 1000 mils, such as a range of about 10 mils to about 500 mils, such as a range of about 10 mils to about 100 mils, or even a range of about 10 mils to about 50 mils.

Embodiment 18. The food sterilization tube or the method of making the food sterilization tube of any of embodiments 9-17, wherein the outer layer has a thickness greater than a thickness of the fluoropolymer layer.

Embodiment 19. The food sterilization tube or the method of making the food sterilization tube of any of the preceding embodiments, wherein the food sterilization tube has a minimum burst resistance of at least 200 psi.

Embodiment 20. The food sterilization tube or the method of making the food sterilization tube of any of the preceding embodiments, wherein the food sterilization tube has a temperature resistance of up to about 400° F.

Embodiment 21. The food sterilization tube or the method of making the food sterilization tube of any of the preceding embodiments, wherein the food sterilization tube is exposed to microwave radiation.

Embodiment 22. The food sterilization tube or the method of making the food sterilization tube of any of the preceding embodiments, wherein the tube has an outside diameter (OD) of up to about 6.0 inches.

Embodiment 23. The food sterilization tube or the method of making the food sterilization tube of any of the preceding embodiments, wherein the tube has an inner diameter (ID) of up to about 2.0 inches.

Embodiment 24. The food sterilization tube or the method of making the food sterilization tube of any of embodiments 9-23, wherein an outside surface of the fluoropolymer layer is surface treated.

Embodiment 25. The food sterilization tube or the method of making the food sterilization tube of embodiment 24, wherein the surface treatment includes mechanical treatment, chemical treatment, or combination thereof.

Embodiment 26. The method of making the food sterilization tube of any of the preceding embodiments, wherein providing the fluoropolymer layer includes extruding the fluoropolymer layer.

Embodiment 27. The method of making the food sterilization tube of any of the preceding embodiments, further including extruding an outer layer.

Embodiment 28. A food sterilization tube including a layer including a fluoropolymer, wherein the fluoropolymer layer has a dielectric constant of less than 3, a tensile strength of at least 1,000 psi at a temperature of 300° F., and a gas permeation rate of less than 1000 (cm³·mil thickness)/(100 in² 24 hr·atm) as measured by ASTM D1434.

Embodiment 29. The food sterilization tube of embodiment 28, wherein fluoropolymer includes a copolymer of tetrafluoroethylene and perfluoropropyl vinyl ether (PFA).

The following examples are provided to better disclose and teach processes and compositions of the present invention. They are for illustrative purposes only, and it must be acknowledged that minor variations and changes can be made without materially affecting the spirit and scope of the invention as recited in the claims that follow.

### EXAMPLES

In an example, a copolymer of tetrafluoroethylene and perfluoroether was extruded under the following conditions: Melt Temperature: 685° F. to 705° F., line speed: 0.25 to 0.50 fpm, quench tank temperature: 80° F. to 90° F., to form a 2.375 inch OD tube. In another example, the copolymer of tetrafluoroethylene and perfluoroether was extruded in a multi-layer configuration with polyether ether ketone under the following conditions: Inner layer melt temperature: 695° F. to 715° F., outer layer melt temperature: 695° F. to 715° F. line speed: 0.40 to 0.80 fpm, quench tank temperature: 95° F. to 110° F., to form a 2.375 inch OD tube. Further testing revealed that high temperature extrusion in combination with slow quenching provided greater tensile strength and burst resistance, measured in excess of 500 psi at 70° F. in a hydraulic burst pressure chamber.

It is contemplated that the melt temperature, quenching, or combination thereof provides greater formation of crystallite particles of advantageous size for better tensile strength compared to a tube process under low temperature extrusion and low temperature quenching. Comparison tubes of the same material with low temperature extrusion and low temperature quenching were found to have lower dimensional uniformity and having lower burst resistance.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. A food sterilization tube comprising:
a layer comprising a fluoropolymer, wherein the fluoropolymer comprises a copolymer of tetrafluoroethylene and perfluoropropyl vinyl ether (PFA), a fluorinated ethylene propylene copolymer (FEP), polytetrafluoroethylene (PTFE), or combination thereof, wherein the fluoropolymer has a dielectric constant of less than 3 as measured by ASTM D150.

2. The food sterilization tube in accordance with claim 1, wherein the fluoropolymer comprises a copolymer of tetrafluoroethylene and perfluoropropyl vinyl ether (PFA).

3. The food sterilization tube in accordance with claim 1, wherein the fluoropolymer has a dielectric constant of 1 to 3, such as 1.5 to 2.5, or even 1.8 to 2.3 as measured by ASTM D150.

4. The food sterilization tube in accordance with claim 1, wherein the fluoropolymer layer has a tensile strength of at least 1000 psi at a temperature of 300° F.

5. The food sterilization tube in accordance with claim 1, wherein the fluoropolymer layer has a gas permeation rate of less than 1000 (cm³·mil thickness)/(100 in²·24 hr·atm) as measured by ASTM D1434.

6. The food sterilization tube in accordance with claim 1, wherein the fluoropolymer layer has a surface having a surface roughness (Ra) of 4.5 μin or less, as measured by ASTM D7127.

7. The food sterilization tube in accordance with claim 1, having an inner surface that defines a central lumen of the tube.

8. The food sterilization tube in accordance with claim 1, further comprising an outer layer comprising a polymer having a tensile strength at yield of at least 1,000 psi at a temperature of 300° F.

9. The food sterilization tube in accordance with claim 8, wherein the polymer outer layer has a tensile strength at yield greater than 1,000 psi, such as greater than 1,500 psi, or even greater than 2,000 psi, as measured by ASTM D3307.

10. The food sterilization tube in accordance with claim 8, wherein the polymer of the outer layer has a dielectric constant of less than 3 as measured by ASTM D150.

11. The food sterilization tube in accordance with claim 8, wherein the polymer of the outer layer comprises a polyimide (PI), a polyamide imide (PAI), a copolymer of tetrafluoroethylene and perfluoropropyl vinyl ether (PFA), a polyether ether ketone (PEEK), a polyphenylene sulfide (PPS), a polysulfone (PSU), a polyether imide (PEI), or combination thereof.

12. The food sterilization tube in accordance with claim 8, wherein the outer layer is disposed directly on the fluoropolymer layer.

13. The food sterilization tube in accordance with claim 1, wherein the fluoropolymer layer has a thickness of less than about 250 mils, such as about 1 mil to about 250 mils, such as about 50 mils to about 250 mils, or about 100 mils to about 230 mils.

14. The food sterilization tube in accordance with claim 1, wherein the tube has a minimum burst resistance of at least 200 psi.

15. The food sterilization tube in accordance with claim 1, wherein the tube has a temperature resistance of up to about 400° F.

16. The food sterilization tube in accordance with claim 1, wherein the food sterilization tube is exposed to microwave radiation.

17. A method of making a food sterilization tube comprising:
providing a layer comprising a fluoropolymer, wherein the fluoropolymer comprises a copolymer of tetrafluoroethylene and perfluoropropyl vinyl ether (PFA), a fluorinated ethylene propylene copolymer (FEP), or combination thereof, wherein the fluoropolymer has a dielectric constant of less than 3 as measured by ASTM D150.

18. The method of making the food sterilization tube in accordance with claim 17, wherein providing the fluoropolymer layer comprises extruding the fluoropolymer layer.

19. The method of making the food sterilization tube in accordance with claim 17, further comprising extruding an outer layer.

20. A food sterilization tube comprising:
a layer comprising a fluoropolymer, wherein the fluoropolymer layer has a dielectric constant of less than 3 as measured by ASTM D150, a tensile strength of at least 1,000 psi at a temperature of 300° F., and a gas permeation rate of less than 1000 (cm³·mil thickness)/(100 in²·24 hr·atm) as measured by ASTM D1434.
